(19) United States
(12) Patent Application Publication
(10) Pub. No.: US 2026/0145999 A1
(43) Pub. Date: May 28, 2026

(54) MATERIALS AND METHODS FOR DEVELOPING BRINE SLUDGE ACTIVATED NATURAL POZZOLAN BASED ALKALI ACTIVATED BINDER

(71) Applicants: SAHARA INTERNATIONAL PETROCHEMICAL COMPANY (SIPCHEM), Dhahran (SA); KING FAHD UNIVERSITY OF PETROLEUM AND MINERALS, Dhahran (SA)

(72) Inventors: Mohammed IBRAHIM, Dhahran (SA); Zaid A. KHALLAF, Dhahran (SA); Mohammed MASLEHUDDIN, Dhahran (SA); Sekhar B. MAMILLA, Dhahran (SA)

(73) Assignees: SAHARA INTERNATIONAL PETROCHEMICAL COMPANY (SIPCHEM), Dhahran (SA); KING FAHD UNIVERSITY OF PETROLEUM AND MINERALS, Dhahran (SA)

(21) Appl. No.: 18/963,128

(22) Filed: Nov. 27, 2024

(51) Int. Cl. C04B 12/04; C04B 7/13; C04B 14/28

(52) U.S. Cl. CPC C04B 12/04; C04B 7/13; C04B 14/28

(57) ABSTRACT

A method of producing concrete, including mixing natural pozzolan and an activator including sodium silicate and brine sludge to form an alkali activated binder; and mixing a coarse aggregate and a fine aggregate with the activated alkali binder to form the concrete, where a density of the brine sludge is about 100 kg/m³, a ratio of the sodium silicate to the brine sludge is about 2.5 to 1 by mass, and an oxide composition of the brine sludge comprises 15-20 wt % CaO, 2-6 wt % MgO, 0.5-2 wt % SrO, 0.5-2 wt % Fe₂O₃, 0.5-1.5 wt % SiO₂, 0-0.5 wt % SO₃, 12-18 wt % Na₂O, 7-10 wt % BaO, 2-5 wt % Al₂O₃, 0.25-1 wt % K₂O, and 5-10 wt % Cl, and a loss on ignition of 35-45 wt %. An alkali activated binder, including: natural pozzolan; and an alkali activator including sodium silicate and brine sludge. A concrete, including: the alkali activated binder; coarse aggregate; and fine aggregate.

### BACKGROUND

### Field of the Invention

The present disclosure relates to alkali activated binders, cement compositions, mortars, cured compositions thereof and concretes thereof. The present disclosure also relates to alkali activated binders comprising brine sludge and natural pozzolan, and methods of making thereof.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The substitution of ordinary Portland cement (OPC) with alternate materials with lower carbon footprint is a main goal of the worldwide concrete industry. The manufacture of OPC generates enormous quantities of carbon dioxide (CO₂), representing about 5-7% of human-made CO₂ emissions. Generally, the manufacture of one ton of OPC releases almost a ton of CO₂ into the atmosphere. With worldwide cement production being about 4.2 billion tons per year, cement manufacturing releases approximately 4 billion tons CO₂ every year.

Additionally, cement is generally the most costly component of concrete. Reducing the amount of cement, typically present in the form of cementitious binders, would significantly reduce the overall costs of forming concrete.

In forming traditional alkaline activated cementitious binders, alkaline compounds, particularly sodium hydroxide and sodium silicate, are used to activate an aluminosilicate material. Sodium hydroxide, also known as caustic soda, is produced industrially through the chlor-alkali process, which involves the electrolysis of a sodium chloride brine. The formation of caustic soda is both energy-intensive and expensive, leading to an average market cost of caustic soda that can be above $1,000 per ton.

Therefore, methods of reducing the amount of cement in concrete are needed, both to reduce CO₂ emissions and to reduce the cost of concrete. Additionally, replacing sodium hydroxide activators with more cost-effective and environmentally friendly materials, such as by-products of current industrial processes, are also needed.

### SUMMARY

Some embodiments of the present disclosure are directed to a method of producing concrete. The method may include: mixing natural pozzolan and an activator including sodium silicate and brine sludge to form an alkali activated binder; and mixing a coarse aggregate and a fine aggregate with the activated alkali binder to form the concrete, where: a density of the brine sludge is about 100 kg/m³, a ratio of the sodium silicate to the brine sludge is about 2.5 to 1 by mass, and an oxide composition of the brine sludge comprises 15-20 wt % CaO, 2-6 wt % MgO, 0.5-2 wt % SrO, 0.5-2 wt % Fe₂O₃, 0.5-1.5 wt % SiO₂, 0-0.5 wt % SO₃, 12-18 wt % Na₂O, 7-10 wt % BaO, 2-5 wt % Al₂O₃, 0.25-1 wt % K₂O, and 5-10 wt % Cl, determined according to ASTM C114, and a loss on ignition (LOI) of 35-45 wt %, determined according to ASTM C114.

Some embodiments of the present disclosure are directed to an alkali activated binder, including: natural pozzolan; and an alkali activator including sodium silicate and brine sludge, where: a density of the brine sludge is about 100 kg/m³, a ratio of the sodium silicate to the brine sludge is about 2.5 to 1 by mass, and an oxide composition of the brine sludge comprises 15-20 wt % CaO, 2-6 wt % MgO, 0.5-2 wt % SrO, 0.5-2 wt % Fe₂O₃, 0.5-1.5 wt % SiO₂, 0-0.5 wt % SO₃, 12-18 wt % Na₂O, 7-10 wt % BaO, 2-5 wt % Al₂O₃, 0.25-1 wt % K₂O, and 5-10 wt % Cl, determined according to ASTM C114, and a loss on ignition (LOI) of 35-45 wt %, determined according to ASTM C114.

Some embodiments of the present disclosure are directed to a concrete, including: the alkali activated binder; a coarse aggregate comprising crushed limestone; and a fine aggregate comprising dune sand.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 shows an XRD pattern of a brine sludge according to certain embodiments.

FIG. 2 shows a sample mixture of brine sludge and sodium silicate, according to certain embodiments.

FIG. 3 shows demolded concrete specimens, according to certain embodiments.

FIG. 4 shows setting times for alkali activated mixtures, according to certain embodiments.

FIG. 5 shows compressive strength development of concrete mixtures, according to certain embodiments.

FIG. 6 shows the flexural strength of concrete mixtures, according to certain embodiments.

FIG. 7 shows the modulus of elasticity of concrete mixtures, according to certain embodiments.

FIG. 8 shows the drying shrinkage profile of natural pozollan activated with sodium silicate and sodium hydroxide, according to certain embodiments.

FIG. 9 shows the drying shrinkage profile of natural pozollan activated with sodium silicate and brine sludge, according to certain embodiments.

FIG. 10 shows the drying shrinkage profile of 90% natural pozollan and 10% ordinary Portland cement, activated with sodium silicate and brine sludge, according to certain embodiments.

FIG. 11 shows the 28-day and maximum drying shrinkage strain in concretes, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

As used herein, the term “natural pozzolan” means a type of naturally-occurring aluminosilicate material, generally of volcanic origin that, when reacted with calcium hydroxide in the presence of water, can form a solid material having cementitious properties. Its cementitious properties depend on the amounts of reactive SiO₂ and Al₂O₃ present in the aluminosilicate.

As used herein, the term “cementitious,” “cementitious material,” and the like, means having cement-like properties, including being curable, where curing includes setting, hardening, and/or adhering when combined with other materials, such as coarse and/or fine aggregates, and with water.

As used herein, the term “brine sludge” means an industrial waste product formed in the chlor-alkali process during the production of caustic soda. Brine sludge typically includes multiple components, with main components including calcium carbonate, magnesium hydroxide, and other insoluble salts such as sodium chloride, as well as impurities including silica and clay minerals. Brine sludge has an alkaline pH at least in part due to the presence of Na and Cl in the mixture. At least a part of the alkalinity of brine sludge may come from hydroxide ions. It is usually disposed of in industrial landfills.

Brine sludge is generally a solid by-product which is formed as a precipitate from the coagulation-flocculation process from the treatment of brine solutions in the chlorine industry. In some cases, industrial brine sludge precipitate may be removed from the industrial process in the form of a heavily viscous slurry, which can be dried to form a solid dry brine sludge powder.

Brine sludge may include heavy metals leftover from industrial production. These heavy metals, some of which may be toxic, can be removed from brine sludge before use, such as by sorption with aluminum silicate matrices. The composition of brine sludge varies around the world, and it typically contains a large number of components, with barite, brucite, calcite, illite, quarts and halite phases being phases present in some brine sludges. The elemental composition of brine sludge typically includes Ca, Si, Na, Mg, Al, Cl, P, S, Fe, Ti, Mn and K. Varying functional groups can be present in brine sludge, including carbonate, oxide, siloxane, and hydroxide. Typical particle sizes of brine sludge are in the range of from 100 nm to 1 mm, such as 100 nm to 100 μm, or 1 μm to 500 μm, or 1 μm to 100 μm, or 1 μm to 30 μm. [[Note to the inventors: please let us know if you approve this description of brine sludge or have a preferred description of the brine sludge of your invention.]]

As used herein, the term “alkali activated binder” means a material having cementitious properties, which is produced by activating an aluminosilicate precursor using an alkaline medium. An alkali activated binder may or may not contain cement as a component.

As used herein, the term “room temperature” means a temperature of from about 20° C. to about 25° C., preferably 25° C.

As used herein, the term “crystallinity,” “crystalline material,” and the like, refers to a material, generally a solid material, where at least some of the atoms, molecules, or ions of the crystalline material have an ordered structure, such as being arranged in a highly ordered, repeating pattern or lattice throughout a crystalline portion of the material. A crystalline material may be partially crystalline, containing one or more crystalline phases that are present in addition to one or more non-crystalline phases, such as amorphous phases that may be solid or liquid. The crystalline and non-crystalline phases may be intermixed in the material. A crystalline material may comprise multiple different crystalline phases, where each phase can independently have the same chemical composition or different chemical compositions.

Some embodiments of the present disclosure are directed to environmentally friendly alkali activated binders, cementitious compositions thereof, and concretes thereof. The alkali activated binders may be formed by activating indigenous natural pozzolan with brine sludge. As used herein, the term “indigenous,” as used in the context of pozzolan, means that the pozzolan is sourced from a natural location. The alkali activated binders, and specifically concretes formed using these binders, may have considerable structural strength, thus making them highly useful for cast in-situ structural applications. For example, the alkali activated binder of the present disclosure, or concrete thereof, may replace all, or a large portion of, the cement content present in the cementitious binder of conventional curable materials such as alkali activated binders, thus significantly reducing CO₂ emissions of producing the binder. Additionally, the alkali activated binders provide an efficient and effective way of safely disposing hazardous industrial waste, such as brine sludge, thus reducing soil and groundwater contamination that occurs when disposing industrial waste in landfills.

In some embodiments, brine sludge is used to activate natural pozzolan by substituting for sodium hydroxide as an alkaline activator. The resulting alkali activated binder has multiple benefits, including the effective utilization of industrial waste, conservation of land currently being used for disposal, and curbing of greenhouse gas emissions caused by production of cement and caustic soda.

Advantages of a brine sludge activated natural pozzolan based alkali activated binder (AAB), as described herein, include:
i. Brine sludge, an industrial waste material, can be used as a component in the alkaline activator to activate natural pozzolan for the synthesis of AAB.
ii. The AAB is environmentally friendly as it replaces almost the entire cement content of traditional binders, where cement content is highly energy intensive generating significant greenhouse gases.
iii. The AAB is a cost-effective material.
iv. The AAB can be utilized for several applications, including structural and non-structural purposes.
v. The developed concrete may be utilized in widespread industrial applications.
vi. The use of the AAB promotes effective utilization of industrial waste and conservation of land currently being used for the disposal of environmentally hazardous materials.

Some embodiments of the present disclosure are directed to a method of producing concrete comprising an alkali activated binder. The method of producing concrete may comprise mixing natural pozzolan and an activator comprising sodium silicate and brine sludge, to form an alkali activated binder.

In some embodiments, a density of the brine sludge may be from about 50 to about 150 kg/m³. For example, the density of the brine sludge may be about 150, 125, 100, 75, or 50 kg/m³. A ratio of the sodium silicate to the brine sludge may be about 2.5 to 1 by mass, such as about 3.0 to 1 by mass, 2.75 to 1 by mass, 2.25 to 1 by mass, or 2 to 1 by mass. An oxide composition of the brine sludge may include 15-20 wt % CaO, 2-6 wt % MgO, 0.5-2 wt % SrO, 0.5-2 wt % Fe₂O₃, 0.5-1.5 wt % SiO₂, 0-0.5 wt % SO₃, 12-18 wt % Na₂O, 7-10 wt % BaO, 2-5 wt % Al₂O₃, 0.25-1 wt % K₂O, and 5-10 wt % Cl, determined according to ASTM C114, and a loss on ignition (LOI) of 35-45 wt %, determined according to ASTM C114. For example, the CaO composition may be 18-19 wt %, such as 18.8 wt % or 18.9 wt %. The MgO composition may be 3-5 wt %, such as 4-5 wt %, or about 4.35 wt %. The SrO composition may be 1-1.5 wt %, such as 1-1.25 wt %, such as about 1.11 wt %. The Fe₂O₃ composition may be 1-1.5 wt %, such as about 1.1 wt % or about 1.2 wt %. The SiO₂ composition may be 0.75-1.0 wt %, such as 0.8-0.9 wt %, such as about 0.89 wt %. The SO₃ composition may be 0.25-0.3 wt %, such as 0.27-0.3 wt %, such as about 0.29 wt %. The Na₂O composition may be 14-15 wt %, such as 14.0-14.5 wt %, such as about 14.36 wt %. The BaO composition may be 8-9 wt %, such as 8.5-9 wt %, such as about 8.58 wt %. The Al₂O₃ composition may be 3-3.5 wt %, such as 3.1-3.3 wt %, such as about 3.25 wt %. The K₂O composition may be 0.5-1 wt %, such as 0.5-0.75 wt %, such as about 0.66 wt %. The Cl composition may be 6-7 wt %, such as 6.5-7 wt %, such as about 6.66 wt %. The loss on ignition (LOI) may be 38-40%, such as 39-40%, such as about 39.9%.

In some embodiments, the brine sludge may be at least partially crystalline. The brine sludge may comprise one crystalline phase, or may include multiple crystalline phases therein. The brine sludge may be at least partially crystalline, and may include one or more main crystalline phases such as calcium carbonate in a form of calcite and aragonite, sodium chloride in a form of halite, magnesium hydroxide in a form of brucite, and quartz, determined according to x-ray diffraction (XRD). For example, the brine sludge may have a crystalline calcium carbonate phase of 10-30 wt %, relative to the total weight of the brine sludge, such as 10-20 wt %, such as 15-20 wt %, such as about 18 wt % or about 18.88 wt %. The brine sludge may have a crystalline sodium chloride phase, relative to the total weight of the brine sludge, of 1-30 wt %, such as 1-10 wt %, such as 2-6 wt %. The brine sludge may have a crystalline magnesium hydroxide phase, relative to the total weight of the brine sludge, of 0-30 wt %, such as 1-10 wt %.

The brine sludge may have a total crystalline component of 0-100 wt %, such as 0-50 wt %, or 50-100 wt %, such as 30-50 wt %, 50-70 wt %, 70-90 wt %, or 90-100 wt %, with the remainder being made up on non-crystalline phases, including amorphous phases and/or liquid phases.

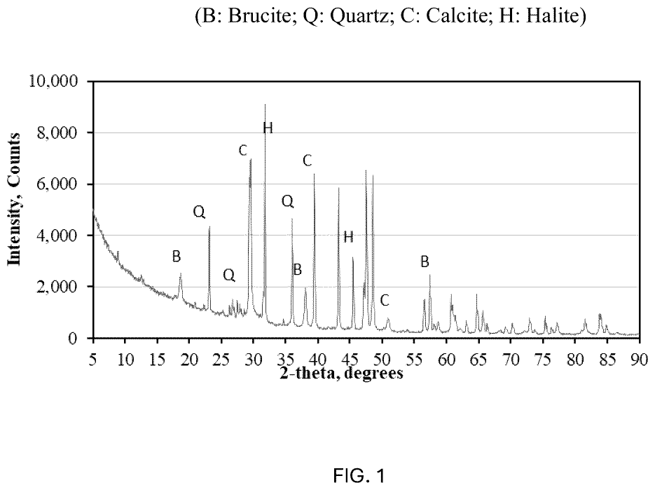

In some embodiments, the brine sludge may have an X-ray diffraction (XRD) pattern as shown in FIG. 1. FIG. 1 shows a brine sludge XRD pattern for a brine sludge having four main crystalline phases: brucite (peaks indicated as “B” in FIG. 1), quartz (peaks indicated as “Q”), calcite (peaks indicated as “C”), and halite (peaks indicated as “H”). The XRD pattern shows three sharp peaks at 20 values of approximately 18°, 37°, and 57°, indicating the presence of brucite. The XRD also shows two sharp peaks at 2θ values of approximately 24° and 36°, and a more diffuse set of peaks clustered at approximately 27°, indicating the presence of quartz in the brine sludge. The sharp quartz peak heights are approximately twice as high as the brucite peak heights. The XRD pattern also shows two sharp peaks at 2θ values of 32° and 46°, indicating the presence of halite in the brine sludge. The halite peak at 32° is the tallest peak in the spectrum, indicating a large relative component of NaCl in the form of halite in the brine sludge. The XRD pattern also shows two sharp peaks at approximately 29° and 51°, which indicates the presence of calcite in the brine sludge. In some embodiments, the XRD pattern may have additional sharp peaks indicating additional crystalline components which do not correspond to any of brucite, quarts, calcite, or halite, such as the two peaks at approximately 47°-48° shown in FIG. 1, or the multiple clusters of short peaks shown above 60° in FIG. 1.

In some embodiments, the sodium silicate may include about 25-35 wt % SiO₂, 10-20 wt % Na₂O, and 40-70 wt % H₂O. The sodium silicate may have a SiO₂/Na₂O ratio of 2.0 to 3.0, and a specific gravity of 1.25-1.75 g/cc. For example, the SiO₂ component may be 30-35 wt %, such as 30-32 wt %, such as about 31.5 wt %. The Na₂O component may be about 13-15 wt %, such as about 14.0%. The H₂O component may be about 50-60 wt %, such as about 55 wt %. The SiO₂/Na₂O ratio may be from 2.0-2.5, such as about 2.25. The specific gravity may be from 1.4-1.6 g/cc, such as about 1.5 g/cc.

In some embodiments, the method of producing concrete may include mixing a coarse aggregate and a fine aggregate with the activated alkali binder to form the concrete.

The mixing is not particularly limited, and ways of mixing concrete are known to the person of ordinary skill in the art. The mixing may be accomplished using a paddle-wheel mixer, a batch mixer, a drum mixer, a tilting-drum mixer, a reversing drum mixer, a continuous mixer, or a twin-shaft mixture. The ingredients may be mixed together in any particular order. For example, the coarse and fine aggregates first may be added to the mixer first, followed by the activated natural pozzolan. Other ingredients, for example water, may be added to the mixing of the alkali activated binder, to the mixing of the coarse aggregate and the fine aggregate, or the mixing of the binder and the aggregates.

The coarse aggregate is not particularly limited, and may include any granular material used in construction, such as crushed rock or other naturally occurring material. Generally, a coarse aggregate may be categorized as having particles larger than a No. 4 sieve, such as larger than 3/16 inches, and less than 2 inches. In some embodiments, the coarse aggregate comprises crushed limestone. The crushed limestone may have a specific gravity of 2.4-2.8 g/cc, a water absorption of 1-3%, or both. For example, the crushed limestone may have a specific gravity of 2.5-2.7 g/cc, such as 2.55-2.65 g/cc, such as about 2.6 g/cc. The crushed limestone may have a water absorption of 2-3%, such as 2-2.5%, such as about 2.2%.

The fine aggregate is not particularly limited, and may include sand, small particles of crushed stone, or crushed slag. Generally, a fine aggregate may have particle sizes that are 0.25 inches or smaller. In some embodiments, the fine aggregate can comprise dune sand. The dune sand may have a specific gravity of 2.4-2.8 g/cc, a water absorption of 0.2-1%, and/or a fineness of 1.5-2.0. For example, the dune sand may have a specific gravity of 2.5-2.7 g/cc, such as 2.5-2.6 g/cc, such as about 2.56 g/cc. The dune sand may have a water absorption of 0.25-0.75%, such as 0.5-0.6%, such as about 0.5%. The dune sand may have a fineness modulus of 1.6-1.9, such as 1.8-1.9, such as about 1.84.

In some embodiments, the method of forming concrete includes mixing cement into the alkali activated binder. The ratio of the natural pozzolan to the cement may be about 20 to 1, or about 18 to 1, or about 16 to 1, or about 14 to 1, or about 12 to 1, or about 10 to 1, or about 8 to 1, or about 6 to 1, or about 4 to 1, or about 2 to 1, or about 1 to 1.

The cement may be ordinary Portland cement (OPC). Ordinary Portland cement is a common type of cement used in construction. It is a fine powder made from a mixture of limestone and clay or shale, which are heated in a kiln to produce clinker. This clinker is then ground to a fine powder and mixed with a small amount of gypsum to control the setting time. OPC is categorized into different grades based on strength, such as 33, 43, and 53 MPa.

The Portland cement, or ordinary Portland cement, may be a Type I, II, III or V ASTM construction cement. For example, Type II may be desirable where moderate heat of hydration is required. Type III or high early cement may be desirable when early compressive strength is needed. Type V may be desirable when high sulfate resistance is required.

The specific grade of ordinary Portland cement used in the particular disclosure is not particularly limited, and may vary according to the specific application.

In some embodiments, the cement may comprise other cementitious components, such as one or more of Portland cement, fly ash, slag, silica fume, gypsum, limestone and/or bentonite.

Any of the oil well type cements of the class “A-H” as listed in the API Spec 10A, (22nd ed., January 1995 or alternatively ISO 10426-1), are suitable. Especially preferred is Portland cement, preferably an API Class A, C, G or H cement.

In some embodiments, the ordinary Portland cement can replace from 1% to 50% of the natural pozzolan in the alkali activated binder. For example, the ordinary Portland cement can replace 1-30%, or 1-20%, 1-10%, 10-20%, or 5-15%, or 8-12%, or about 5%, about 6%, about 7%, about 8%, about 9%, about 10%, about 11%, about 12%, about 13%, about 14%, or about 15% of the natural pozzolan in the alkali activated binder.

In some embodiments, the method of forming the concrete may include curing the concrete. The curing may include a one-day heat curing, at approximately 60° C. to 80° C., such as 70° C., followed by a room-temperature curing for at least six days, such as about 10 days, about 20 days, about 30 days, about 60 days, about 90 days, or longer. In some embodiments, the curing may include a continuous curing at a temperature of 21° C. to 25° C. and a humidity of 45% to 55%. The continuous curing may occur for 6 days, about 10 days, about 20 days, about 30 days, about 60 days, about 90 days, or longer.

In some embodiments, the concrete may have a compressive strength of at least 25 MPa, such as at least 27 M, at least 30 MPa, at least 35 MPa, at least 40 MPa, at least 45 MPa, at least 50 MPa, at least 55 MPa, or higher.

The concrete may have a flexural strength of from 2.5 MPa to 3.8 MPa. The concrete may have a modulus of elasticity from 8.0 GPa to 16.2 GPa.

The alkali activated binder may have an average compressive strength of at least 9.5 MPa, such as at least 10 MPa, at least 15 MPa, or at least 20 MPa.

The alkali activated binder may have an initial setting time of 45 minutes or more. The concrete may have a final setting time of 375 minutes or less. The setting times of the concrete may conform to the ASTM C150 standards for conventional cementitious materials. In some embodiments, the average initial setting time is about 85 minutes or less, and the average final setting time is about 135 minutes or less.

The alkali activated binder may have a flow greater than about 120 mm and less than about 180 mm, for example in a range of from about 130 mm to about 152 mm.

Numerous modifications and variations of the present disclosure are possible in light of the above teachings. It is therefore to be understood that within the scope of the appended claims, the invention may be practiced otherwise than as specifically described herein.

### EXAMPLES

### Example 1: Optimized Ratio of Sodium Silicate to Brine Sludge

In this example, brine sludge was used to activate natural pozzolan by substituting sodium hydroxide solution in the alkaline activator. To set the ratio of sodium silicate (SS) to brine sludge (BS), the ratio was varied from 1 to 2.5 to activate natural pozzolan (NP). The total alkaline activator content was also varied to obtain a workable mix. A 1-day heat curing at 70° C. and 6-days room temperature curing produced compressive strength magnitude of about 10 MPa for the mix produced with a ratio of SS/BS of 2.5 having total alkaline activator content of 350 kg/m³. Significant improvement in the compressive strength was observed when 10% of NP was replaced with ordinary Portland cement. The improved compressive strength was about 30 MPa cured for 90 days at room temperature conditions.

### Materials

Brine sludge, supplied by SIPCHEM, was used to activate natural pozzolan as a component in the alkaline activator. The raw BS was mainly composed of Calcite. The other elements include Si, Mg, Na, Ba and Cl. The XRD pattern of the raw brine sludge, as shown in FIG. 1, confirmed the crystalline nature of the compounds and indicated that the main phases in the brine sludge were calcium carbonate in the form of calcite and aragonite, halite (sodium chloride), brucite (magnesium hydroxide), and quartz (SiO₂). The chemical composition of raw brine sludge is displayed in Table 1, determined in accordance with ASTM C114 [ASTM C114 (2016). Standard Test Methods for Chemical Analysis of Hydraulic Cement, Annual Book of ASTM Standards, American Society for Testing and Materials, West Conshohocken, PA, which is incorporated herein by reference in its entirety].

TABLE 1
chemical composition of brine sludge.

| Oxides | Weight, % |
|---|---|
| CaO | 18.88 |
| MgO | 4.35 |
| SrO | 1.11 |
| Fe₂O₃ | 1.07 |
| SiO₂ | 0.89 |
| SO₃ | 0.29 |
| Na₂O | 14.36 |
| BaO | 8.58 |
| Al₂O₃ | 3.25 |
| K₂O | 0.66 |
| Cl | 6.66 |
| LOI | 39.9 |

Industrial grade sodium silicate solution obtained from SAMACHEM located in second industrial city, Dammam, was used in the study. The chemical and physical characteristics of sodium silicate are displayed in the Table 2.

TABLE 2
chemical composition and physical properties of sodium silicate

| SiO₂, % | Na₂O, % | H₂O, % | SiO₂/Na₂O | Specific gravity, g/cc |
|---|---|---|---|---|
| 31.5 | 14.0 | 55.0 | 2.25 | 1.50 |

For producing concrete, crushed limestone and dune sand were used as coarse and fine aggregate, respectively. The specific gravity, water absorption and fineness modulus of dune sand were about 2.56 g/cc, 0.5% and 1.84, respectively. The specific gravity and water absorption of coarse aggregate were 2.6 g/cc and 2.2%, respectively.

### Mix Details and Preparation of Concrete Specimens

BS was used as an activator to synthesize NP-based alkali activated binder (AAB). Conventionally, aluminosilicious precursor materials have been activated using alkaline materials composed of sodium silicate (SS) and sodium hydroxide (SH) solutions. However, given the alkaline nature of the brine sludge, it was used as a component in the alkaline activator, replacing sodium hydroxide solution.

The trial mixtures TAAC1 to TAAC8 were prepared by activating NP by varying the composition of alkaline activator. Table 3 shows the proportions of the materials used in the trial mixtures. The SS/BS ratio was varied between 1 and 2.5. The workability of mixes was measured by flow table. For the trial mixes, the compressive strength of concrete was measured after a total of 7-days of demolding in which they were cured for 1-day in the oven at 70±2° C. and 6-days in the laboratory maintained at temperature and humidity of 23±2° C. and 55±5% humidity, respectively.

TABLE 3
Proportions of materials in trial mixtures prepared with varying
proportions of BS. (AAC = alkali activated concrete).

| Designation | | | | | Coarse | Fine |
|---|---|---|---|---|---|---|
| of trial | | SS, | BS, | SS/BS | aggregate, | aggregate, |
| mixture | NP, kg/m³ | kg/m³ | kg/m³ | ratio | kg/m³ | kg/m³ |
| TAAC1 | 400 | 150 | 60 | 2.5 | 1120 | 746 |
| TAAC2 | 400 | 200 | 80 | 2.5 | 1050 | 700 |
| TAAC3 | 400 | 250 | 100 | 2.5 | 980 | 653 |
| TAAC4 | 400 | 265 | 116 | 2.3 | 951 | 634 |
| TAAC5 | 400 | 240 | 120 | 2.0 | 972 | 648 |
| TAAC6 | 400 | 243 | 143 | 1.7 | 948 | 632 |
| TAAC7 | 400 | 160 | 160 | 1 | 1019 | 680 |
| TAAC8 | 400 | 180 | 180 | 1 | 980 | 653 |

Based on the trial results, a mixture proportion was selected that produced high compressive strength and good workability. Further, to improve the properties of selected NP-based AAC, a nominal quantity of NP about 10% was substituted by OPC.

The proportions of material used in the selected AAC mix, in which 10% NP was replaced with OPC, is shown in Table 4. Conventional alkali activated concrete (AAC) was also produced by activating NP using sodium silicate and 12M sodium hydroxide solution at a weight ratio of 2.5.

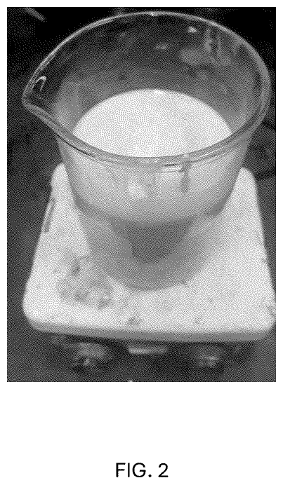

The liquid portion of the AAC mix was prepared prior to adding the required quantity of brine sludge to the sodium silicate solution and thoroughly mixed, as depicted in FIG. 2. For the preparation of concrete specimens, the required quantities of coarse and fine aggregates were weighed, and placed in a paddle mixer to which the precursor material was added. These materials were dry mixed thoroughly followed by the addition of alkaline activator. Every material added to the bowl was mixed for approximately 1 to 2 minutes such that the total mixing time was about 5 to 6 minutes, to ensure the homogeneity of the mixture. Subsequently, the concrete was placed in the molds in two layers and each layer was vibrated for 30 seconds to remove the entrapped air. Then, the surface was carefully finished to a smooth surface using a trowel. The molded specimens were covered with a plastic sheet to prevent moisture loss and kept in the laboratory atmosphere, maintained at 23±2° C., for 24 hours before being de-molded.

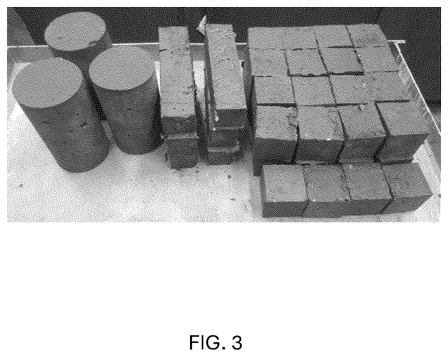

FIG. 3 shows the demolded specimens of varying size and shape. The specimens for measuring compressive strength were divided into two groups. The first group was cured for 1-day in the oven at 70° C. and, subsequently, cured in a laboratory maintained at temperature and humidity of 23±2° C. and 50±5%, respectively, until testing at the predetermined age. The second group was continuously cured in the laboratory conditions until testing age. For the other mechanical properties and durability of AAC, all the specimens were cured at the laboratory conditions until the testing age.

TABLE 4
Material proportions of selected AAC mixes.

| | | | NP, | OPC, | SS, | SH, | BS, | CA, | FA, |
|---|---|---|---|---|---|---|---|---|---|
| Mix | Details | Activator | kg/m³ | kg/m³ | kg/m³ | kg/m³ | kg/m³ | kg/m³ | kg/m³ |
| 100% NP/ | 100% | SS + SH | 400 | — | 150 | 60 | — | 1105 | 737 |
| SS + SH | NP | | | | | | | | |
| 100% NP/ | 100% | SS + BS | 400 | — | 250 | — | 100 | 1015 | 676 |
| SS + BS | NP | | | | | | | | |
| 10% OPC/ | 10% | SS + BS | 360 | 40 | 250 | — | 100 | 982 | 655 |
| SS + BS | OPC | | | | | | | | |

### Example 2: Properties of Concrete Specimens Comprising a Brine Sludge Activated Natural Pozzolan Based Alkaline Activated Binder

Appropriate size and shape of concrete specimens were prepared from each mix and tested to determine the following properties of the concretes:
a. Setting time; according to ASTM C191 [ASTM C191 (2016). Standard Test Methods for Time of Setting of Hydraulic Cement by Vicat Needle, Annual Book of ASTM Standards, American Society for Testing and Materials, West Conshohocken, PA, incorporated herein by reference in its entirety].
b. Flow of mortar; according to ASTM C1437 [ASTM C1437 (2016). Standard Test Method for Flow of Hydraulic Cement Mortar, Annual Book of ASTM Standards, American Society for Testing and Materials, West Conshohocken, PA, incorporated herein by reference in its entirety].
c. Compressive strength; according to ASTM C39 [ASTM C39 (2016). Standard Test Method for Compressive Strength of Cylindrical Concrete Specimens, Annual Book of ASTM Standards, American Society for Testing and Materials, West Conshohocken, PA, incorporated herein by reference in its entirety].
d. Flexural strength; according to ASTM C78 [ASTM C78 (2016). Standard Test Method for Flexural Strength of Concrete (Using Simple Beam with Third-Point Loading), Annual Book of ASTM Standards, American Society for Testing and Materials, West Conshohocken, PA, incorporated herein by reference in its entirety].
e. Modulus of elasticity; according to ASTM C469 [ASTM C469 (2016). Standard Test Method for Static Modulus of Elasticity and Poisson's Ratio of Concrete in Compression, Annual Book of ASTM Standards, American Society for Testing and Materials, West Conshohocken, PA, incorporated herein by reference in its entirety].
f. Drying shrinkage; according to ASTM C157 [ASTM C157 (2016). Standard Test Method for Length Change of Hardened Hydraulic-Cement Mortar and Concrete, Annual Book of ASTM Standards, American Society for Testing and Materials, West Conshohocken, PA, incorporated herein by reference in its entirety].

### Compressive Strength of Trial Mixes.

Table 5 shows the compressive strength of trial mixtures prepared with BS used as an alkaline activator. Trial mixtures were prepared by varying the amounts of BS and SS to obtain suitable workability and high compressive strength. The initial trials were conducted by taking total alkaline activator content of about 210 kg/m³. The total alkaline activator content of 210 kg/m³ (SS: 150 kg/m³+BS: 60 kg/m³) was not enough to produce workable concrete. Consequently, the total alkaline activator content was increased to 280 kg/m³ in the trial mix TAAC2 that produced poor workability of mix; however, it allowed casting of concrete specimens. The average compressive strength was about 5.57 MPa after 1-day heat curing plus 6-days at room temperature. The total alkaline activator content was further increased to 350 kg/m³, keeping SS/BS ratio of 2.5 (SS: 200 kg/m³+BS: 100 kg/m³) that produced good workability. This AAC mixture exhibited an average compressive strength of 9.61 MPa. Further trial mixtures were prepared by increasing the quantity of BS in the alkaline activator from 116 to 180 kg/m³, by varying the SS/BS ratio from 2.3 to 1.0. The results show that an increase in the quantity of BS decreased the compressive strength, except for the mixture prepared with a SS/BS ratio of 1.7 (TAAC6). A SS/BS ratio of 1.0 was used in a trial mixture, namely TAAC8, in which the quantity of both SS and BS was 180 kg/m³, the workability was poor, and the compressive strength was the lowest among all the trial mixtures, being 0.35 MPa. Therefore, an AAC mixture with a SS/BS ratio of 2.5, and with 250 and 100 kg/m³ of SS and BS, respectively, was selected for further evaluation. Further, to improve the properties of NP-based AAC, NP was partially replaced with OPC.

TABLE 5
Compressive strength of trial mixtures prepared with brine sludge as an activator.

| | NP, | SS, | BS, | SS/BS, | | Compressive strength, MPa | | | |
|---|---|---|---|---|---|---|---|---|---|
| Mix # | kg/m³ | kg/m³ | kg/m³ | ratio | Workability | S1 | S2 | S3 | Avg. |
| TAAC1 | 400 | 150 | 60 | 2.5 | Very poor | Not able to cast | | | |
| TAAC2 | 400 | 200 | 80 | 2.5 | Poor | 5.4 | 6.36 | 4.96 | 5.57 |
| TAAC3 | 400 | 250 | 100 | 2.5 | Good | 9.4 | 9.52 | 9.92 | 9.61 |
| TAAC4 | 400 | 265 | 116 | 2.3 | Good | 4.72 | 5.44 | 4.04 | 4.73 |
| TAAC5 | 400 | 240 | 120 | 2.0 | Good | 4.55 | 5.17 | 4.02 | 4.58 |
| TAAC6 | 400 | 243 | 143 | 1.7 | Good | 5.64 | 5.52 | 4.8 | 5.32 |
| TAAC7 | 400 | 160 | 160 | 1 | Stiff | Not able to cast | | | |
| TAAC8 | 400 | 180 | 180 | 1 | Very poor | 0.4 | 0.32 | 0.32 | 0.35 |

### Setting Times and Workability.

Table 6 shows the setting time of different alkali activated mixtures. The average initial and final setting times of 100% NP activated concrete, using conventional alkaline activator comprising sodium silicate and 12M sodium hydroxide, were 144 and 281 minutes, respectively. However, there was a marginal decrease in the initial and final setting time when 100% NP was activated using SS along with BS, to about 139 min and 276 minutes, respectively. The marginal decrease in the setting time may have been due to the alkaline nature of BS. The lowest values were recorded in the mix containing 10% OPC. Without being bound by theory, the significant decrease in the setting time with the addition of 10% OPC may possibly be due to faster dissolution of precursor material, thus enhancing the polymerization process. ASTM C150 specifies that the initial setting time should be more than 45 minutes, and the final setting time should be 375 minutes or less, for conventional cementitious materials. Hence, the initial and final setting time measured for the various mixes evaluated in this study were within the range stipulated in ASTM C150.

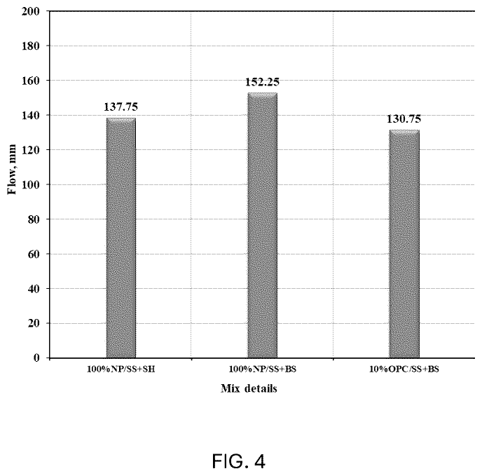

The flow of various alkali activated mortar mixtures is shown in FIG. 4. The workability of all the mixtures was good. The flow ranged from 131 to 152 mm. The lowest flow was recorded in the mixture containing 10% OPC.

TABLE 6
Setting time of alkali activated mixtures.

| | | | Setting time, minutes | | | | | |
|---|---|---|---|---|---|---|---|---|
| | Mixture | | Specimen 1 | | Specimen 2 | | Average | |
| Mix # | composition | Activator | Initial | Final | Initial | Final | Initial | Final |
| AAC0 | 100% NP | SS + SH | 145 | 273 | 143 | 288 | 144 | 281 |
| AAC1 | 100% NP | SS + BS | 140 | 270 | 138 | 281 | 139 | 276 |
| AAC2 | 10% OPC | SS + BS | 78 | 135 | 85 | 129 | 82 | 132 |

### Compressive Strength of Selected Mixes.

As described in the preceding section, the specimens prepared to determine compressive strength of concrete were divided into two batches. The first batch of specimens was cured for one day at 70° C. in the oven. Subsequently, the compressive strength was determined at 1, 3, 7, 28, and 90 days. This curing regime was termed as “heat curing”. The other batch of specimens was cured at room temperature conditions, by continuously keeping them in a laboratory maintained at temperature and relative humidity of 23±2° C. and 50±5%, respectively.

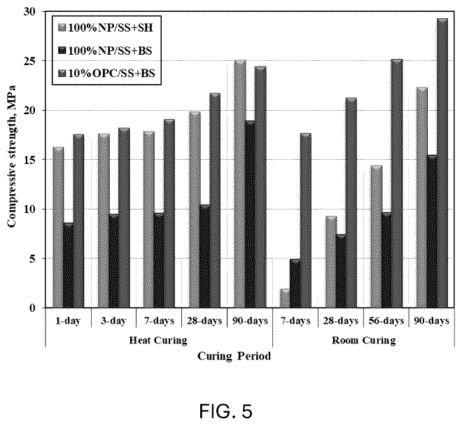

Subsequently, the compressive strength was determined at 7, 28, 56, and 90 days. This curing regime was termed “room temperature” curing. FIG. 5 depicts the compressive strength development of heat cured, as well as room temperature cured, AAC concrete mixtures prepared with brine sludge.

In general, the gain in compressive strength was faster in the AAC specimens that were cured in the oven for 1-day compared to the specimens cured at room temperature conditions. The NP activated with conventional activators, including SS and SH, resulted in a compressive strength of about 19.81 MPa when heat cured and 9.33 MPa when cured continuously at room temperature. Thus, there was nearly a two-fold strength increase in the heat cured specimens.

When the brine sludge was used as a component in the alkaline activator, the compressive strength development was slower in the specimens cured in both curing regimes. The compressive strength obtained at the onset of both the curing regimes was very low for the mix activated using SS+BS.

A 28-days compressive strength of 10.30 and 7.43 MPa was noted in the 100% NP activated using SS and BS heat and room temperature cured, respectively. The 90 days compressive strength was about 18.89 and 15.44 MPa when cured at elevated temperature and room temperature conditions, respectively. There was significant improvement in the compressive strength of AAC when 10% NP was replaced with OPC. It was nearly 25 and 30 MPa after 90 days of curing at heat and room temperature conditions, respectively.

### Flexural Strength and Modulus of Elasticity.

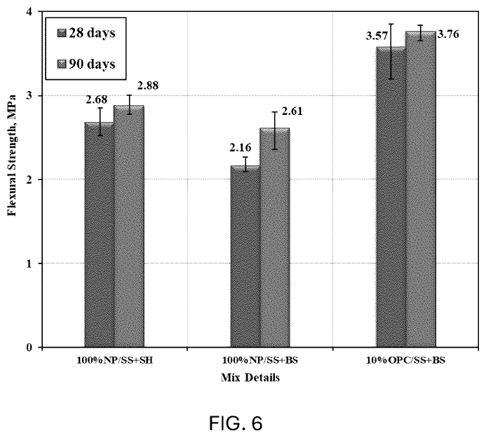

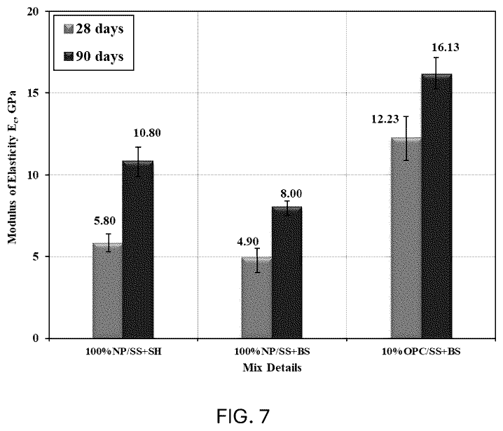

FIG. 6 and FIG. 7 display the flexural strength and modulus of elasticity, respectively, of AAC mixtures prepared with brine sludge. The 90 days flexural strength of AAC was in the range of 2.61 to 3.76 MPa. The lowest value was noted in the 100% NP activated with SS+BS. The modulus of elasticity of the AAC was in the range of 8.0 to 16.13 GPa.

### Drying Shrinkage.

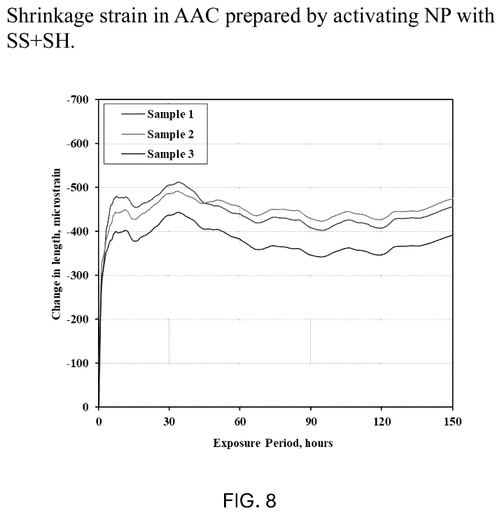

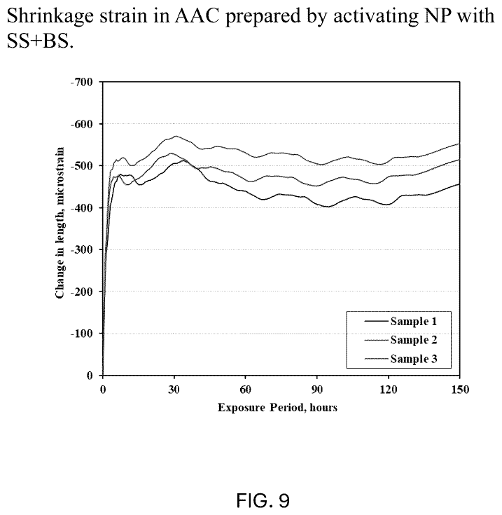

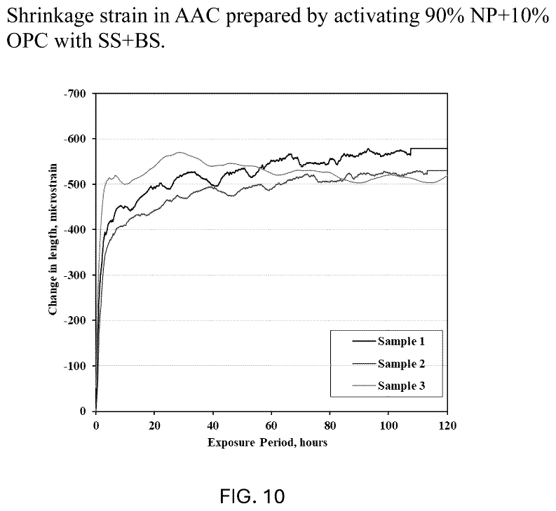

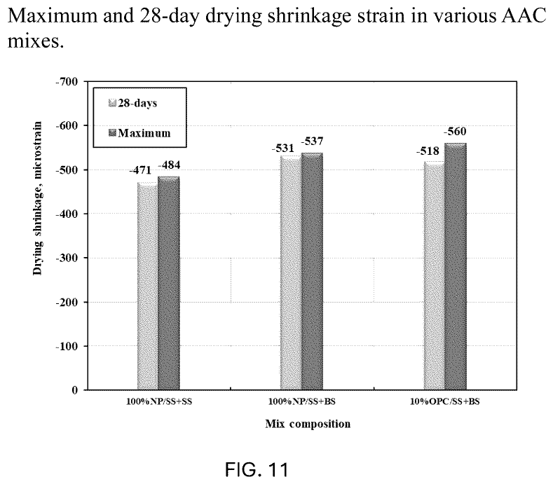

FIG. 8, FIG. 9, and FIG. 10 show the drying shrinkage profile of NP/SS+SH, NP/SS+BS and 90% NP+10% OPC/SS+BS, respectively. After initial curing for 7-days, the specimens were subjected to drying in a laboratory maintained at temperature and relative humidity of 23±2° C. and 50±5%, respectively. In general, the rate of drying shrinkage was rapid during the first seven days of exposure, with no significant increase subsequently. The maximum drying shrinkage was recorded after one month of exposure. After this period, there was marginal fluctuations in the drying shrinkage values. FIG. 11 illustrates the 28-days and maximum drying shrinkage strain in the various AAC mixes. The maximum drying shrinkage was in the range of 484 to 560 micro-strain. The lowest drying shrinkage was in the conventional AAC where 100% NP was activated using SS+SH, and the highest was in the specimens having 10% OPC.

Brine sludge was used as a component in the alkaline activator, replacing sodium hydroxide solution in the alkali activated binder. About 100 kg/m³ of brine sludge, with a sodium silicate to brine sludge ratio of about 2.5, was found to activate natural pozzolan with good workability and reasonable strength.

The NP activated using conventional activators, including sodium silicate and sodium hydroxide, resulted in a compressive strength of about 19.81 MPa when heat cured, and 9.33 MPa when cured continuously at room temperature.

A 28-days compressive strength of 10.30 and 7.43 MPa was noted in the 100% NP activated using sodium silicate and brine sludge, for heat and room temperature cured specimens, respectively. The 90 days compressive strength was about 18.89 and 15.44 MPa when cured at elevated temperature and room temperature conditions, respectively. There was significant improvement in the compressive strength of the concrete when 10% of the natural pozzolan was replaced with ordinary Portland cement. It was nearly 25 MPa and 30 MPa, after 90 days curing in elevated and room temperature conditions, respectively.

The maximum drying shrinkage strain was below 600-micron mark, and it was the lowest in the conventional NP-based concrete.

The present disclosure provides alkali activated binders synthesized by entirely, or almost entirely, replacing ordinary Portland cement with natural pozzolan, and with brine sludge as a component in the alkaline activator. A precursor having 90% NP+10% OPC, activated utilizing sodium silicate and brine sludge, produced compressive strengths acceptable for making structural grade concrete. The inclusion of brine sludge in the alkaline activator improved workability. The alkali activated binders not only replace ordinary Portland cement, but also bring a safe mode for an industrial waste disposal.

1. A method of producing concrete, the method comprising:
mixing a natural pozzolan and an activator comprising sodium silicate and brine sludge to form an alkali activated binder; and
mixing a coarse aggregate and a fine aggregate with the activated alkali binder to form the concrete,
wherein:
a density of the brine sludge is about 100 kg/m³,
a ratio of the sodium silicate to the brine sludge is about 2.5 to 1 by mass,
an oxide composition of the brine sludge comprises 15-20 wt % CaO, 2-6 wt % MgO, 0.5-2 wt % SrO, 0.5-2 wt % Fe₂O₃, 0.5-1.5 wt % SiO₂, 0-0.5 wt % SO₃, 12-18 wt % Na₂O, 7-10 wt % BaO, 2-5 wt % Al₂O₃, 0.25-1 wt % K₂O, and 5-10 wt % Cl, determined according to ASTM C114, and
the brine sludge has a loss on ignition (LOI) of 35-45 wt %, determined according to ASTM C114.

2. The method of claim 1, wherein the mixing includes mixing ordinary Portland cement with at least one of the natural pozzolan and the activator to form the alkali activated binder, wherein a ratio of the natural pozzolan to the ordinary Portland cement is about 10 to 1.

3. The method of claim 1, wherein the brine sludge is at least partially crystalline, comprising main phases of calcium carbonate in a form of calcite and aragonite, sodium chloride in a form of halite, magnesium hydroxide in a form of brucite, and quartz, determined according to x-ray diffraction (XRD).

4. The method of claim 1, wherein the sodium silicate comprises 25-35 wt % SiO₂, 10-20 wt % Na₂O, and 50-60 wt % H₂O, and the sodium silicate has a specific gravity of 1.25-1.75 g/cc.

5. The method of claim 1, wherein the coarse aggregate comprises crushed limestone having a specific gravity of 2.4-2.8 g/cc and a water absorption of 2.0-2.4%.

6. The method of claim 1, wherein the fine aggregate comprises dune sand having a specific gravity of 2.4-2.8 g/cc, a water absorption of 0.25-1%, and a fineness of 1.7-2.0.

7. The method of claim 1, further comprising curing the concrete.

8. The method of claim 7, wherein the curing comprises a one-day heat curing at approximately 70° C., followed by a room temperature curing for at least six days.

9. The method of claim 7, wherein the curing comprises a continuous curing at a temperature of 21° C. to 25° C. and a humidity of 45% to 55%.

10. The method of claim 7, wherein the curing forms a concrete with a compressive strength of at least 25 MPa.

11. The method of claim 2, wherein the alkali activated binder has an average initial setting time of 85 minutes or less and an average final setting time of 135 minutes or less.

12. The method of claim 7, wherein the concrete has a compressive strength of 12 MPa or less after 28 days curing and a compressive strength of 15 MPa or more after 90 days curing.

13. The method of claim 2, wherein the concrete has a flexural strength of from 2.5 MPa to 3.8 MPa and a modulus of elasticity from 8.0 GPa to 16.2 GPa.

14. An alkali activated binder, comprising:
natural pozzolan; and
an alkali activator comprising sodium silicate and brine sludge,
wherein:
a density of the brine sludge is about 100 kg/m³,
a ratio of the sodium silicate to the brine sludge is about 2.5 to 1 by mass, and
an oxide composition of the brine sludge comprises 15-20 wt % CaO, 2-6 wt % MgO, 0.5-2 wt % SrO, 0.5-2 wt % Fe₂O₃, 0.5-1.5 wt % SiO₂, 0-0.5 wt % SO₃, 12-18 wt % Na₂O, 7-10 wt % BaO, 2-5 wt % Al₂O₃, 0.25-1 wt % K₂O, and 5-10 wt % Cl, determined according to ASTM C114, and
wherein the brine sludge has a loss on ignition (LOI) of 35-45 wt %, determined according to ASTM C114.

15. The alkali activated binder of claim 14, further comprising ordinary Portland cement, wherein a ratio of the natural pozzolan to the ordinary Portland cement is about 10 to 1.

16. The alkali activated binder of claim 14, having an average compressive strength of 9.5 MPa or greater.

17. The alkali activated binder of claim 14, having a flow in a range of 131 mm to 152 mm.

18. The alkali activated binder of claim 14, wherein a concrete formed from the alkali activated binder has a compressive strength of at least 25 MPa.

19. The alkali activated binder of claim 14, wherein a concrete formed from the alkali activated binder has a flexural strength of from 2.5 MPa to 3.8 MPa and a modulus of elasticity from 8.0 GPa to 16.2 GPa.

20. A concrete, comprising:
the alkali activated binder of claim 15;
a coarse aggregate comprising crushed limestone; and
a fine aggregate comprising dune sand.
